(19) United States
(12) Patent Application Publication
(10) Pub. No.: US 2013/0016133 A1
(43) Pub. Date: Jan. 17, 2013

(54) BACKLIGHT MODULE AND LIQUID CRYSTAL DISPLAY DEVICE USING THE SAME

(71) Applicants: Chia-Hsin Chen, Taipei City (TW); Tsung-Ping Wei, Taipei City (TW); Chiu-Yuan Lin, Taipei City (TW)

(72) Inventors: Chia-Hsin Chen, Taipei City (TW); Tsung-Ping Wei, Taipei City (TW); Chiu-Yuan Lin, Taipei City (TW)

(73) Assignee: BEYOND INNOVATION TECHNOLOGY CO., LTD., Taipei City (TW)

(21) Appl. No.: 13/467,991

(22) Filed: May 9, 2012

(30) Foreign Application Priority Data
Jul. 11, 2011 (TW) 100124436

(51) Int. Cl. G09G 3/36; G09G 5/10; F21V 13/04; G02F 1/13357; F21V 8/00; F21V 13/02

(52) U.S. Cl. 345/690; 362/612; 362/609; 362/606; 349/65; 345/102

(57) ABSTRACT

A backlight module and a liquid crystal display (LCD) device using the same are provided. The backlight module includes a light-guide plate and a light source module. The light-guide plate has a first side surface and a second side surface, wherein the second side surface is tangent with the first side surface. The light source module is disposed beside the first side surface and the second side surface of the light-guide plate, and a plurality of first light emitting diode (LED) units and a plurality of second LED units are respectively disposed at portions of the light source module that face the first side surface and the second side surface of the light-guide plate. Thereby, the backlight module has the advantages of high image contrast and low power consumption offered by a direct type backlight module and maintains the thickness of a side-edge backlight module.

### CROSS-REFERENCE TO RELATED APPLICATION

This application claims the priority benefit of Taiwan application serial no. 100124436, filed on Jul. 11, 2011. The entirety of the above-mentioned patent application is hereby incorporated by reference herein and made a part of this specification.

### BACKGROUND OF THE INVENTION

1. Field of the Invention

The invention generally relates to a light source module, and more particularly, to a backlight module and a liquid crystal display (LCD) device using the same.

2. Description of Related Art

Liquid crystal display (LCD) device has become the mainstream product in today's display market thanks to its many advantages such as high image quality, high space efficiency, low power consumption, and no radiation. LCD device has been broadly adopted as the display screens of many consumable electronic products, such as TVs, smart phones, and notebook computers. However, because a LCD panel itself does not emit light, a sufficient light source has to be disposed behind the LCD panel to allow the LCD panel to display images.

Backlight modules disposed in LCD devices can be categorized into direct type backlight modules and side-edge backlight modules. In a direct type backlight module, many light emitting diodes (LED) are evenly disposed behind a LCD panel as the light source, and the light beams emitted by these LEDs are evenly diffused by using a diffuser plate, so as to provide a surface light source with high brightness. Because the light emitted by a direct type backlight module passes through the LCD panel and directly enters a user's eyes, a long light mixing distance is required for mixing the light. Accordingly, the thickness of the LCD device cannot be reduced.

On the other hand, in a side-edge backlight module, a light source is installed at one side of the LCD panel, and the light emitted by the light source is mixed into a surface light source by using a light-guide plate before it enters a user's eyes. Thus, by adopting a side-edge backlight module, the thickness of the LCD device can be reduced.

As described above, a side-edge backlight module can reduce the thickness of a backlight module, while a direct type backlight module can adjust the brightness of a partial display area through an image processing chip, a brightness calculation algorithm, or a timing controller capable of parsing an image content. In other words, because in a direct type backlight module, the light sources are evenly distributed within the partial display areas on the LCD panel, the brightness of each display area can be individually adjusted and accordingly the direct type backlight module can have an optimal image contrast and low power consumption. Contrarily, in a side-edge backlight module, it is impossible to adjust the brightness of each display area by using an image processing chip or a brightness calculation algorithm.

### SUMMARY OF THE INVENTION

Accordingly, the invention is directed to a backlight module and a liquid crystal display (LCD) device using the same, wherein the backlight module has the advantages of high image contrast and low power consumption offered by a direct type backlight module and maintains the thickness of a side-edge backlight module.

The invention provides a backlight module including a light-guide plate and a light source module. The light-guide plate has a first side surface and a second side surface, wherein the second side surface is tangent with the first side surface. The light source module is disposed beside the first side surface and the second side surface of the light-guide plate, and a plurality of first light emitting diode (LED) units and a plurality of second LED units are respectively disposed at portions of the light source module that face the first side surface and the second side surface of the light-guide plate.

According to an embodiment of the invention, the backlight module further includes a LED driving module. The LED driving module is coupled to the light source module and respectively controls the luminance of the first LED units and the second LED units. The light-guide plate is divided into a plurality of subareas according to the relative position of the first LED units and the second LED units, and each of the subareas is respectively corresponding to one of the first LED units and one of the second LED units. The LED driving module dynamically adjusts the luminance of the first LED unit and the second LED unit corresponding to each subarea according to an image content corresponding to the subarea.

According to an embodiment of the invention, the extending direction of the first side surface and the extending direction of the second side surface are perpendicular to each other. Additionally, according to an embodiment of the invention, the light source module is an L-shaped LED light bar.

According to an embodiment of the invention, the first LED units and the second LED units are red LEDs, green LEDs, and/or blue LEDs, or a white light source composed of aforementioned LEDs, or any other type of LEDs that can be used as backlight sources.

According to an embodiment of the invention, the backlight module further includes a reflective cover. The reflective cover is disposed beside the first side surface and the second side surface, and the light source module is located between the reflective cover and the light-guide plate.

According to an embodiment of the invention, the backlight module further includes an optical film set disposed beside a light exit surface of the light-guide plate. The optical film set is one or any combination of an optical diffuser, a brightness enhancement film, and a prism sheet.

The invention provides a LCD device including a backlight module and a LCD panel. The backlight module includes a light-guide plate and a light source module. The light-guide plate has a first side surface and a second side surface, wherein the second side surface is tangent with the first side surface. The light source module is disposed beside the first side surface and the second side surface of the light-guide plate, and a plurality of first LED units and a plurality of second LED units are respectively disposed at portions of the light source module that face the first side surface and the second side surface of the light-guide plate. The LCD panel is disposed beside a light exit surface of the light-guide plate, and a surface light source provided by the backlight module is served as a display light source of the LCD panel. Other implementation details of the backlight module in the LCD device can be referred to the description above.

As described above, in a backlight module provided by an embodiment of the invention, an L-shaped LED light bar is disposed beside a first side surface and a tangent second side surface of a light-guide plate. Accordingly, the LCD device can respectively control the LED units in the horizontal direction (for example, the first side surface) and the vertical direction (for example, the second side surface) on the L-shaped LED light bar, so as to dynamically adjust the brightness of each display area on the LCD device. Thereby, the backlight module in the present embodiment has the advantages of high image contrast and low power consumption offered by a direct type backlight module and maintains the thickness of a side-edge backlight module.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a backlight module according to a first embodiment of the invention.

FIG. 2 is a cross-sectional view of the backlight module in FIG. 1 along a vertical line I-I′.

FIG. 3 is a cross-sectional view of a liquid crystal display (LCD) device according to the first embodiment of the invention.

FIG. 4 is a top view of a LCD device according to the first embodiment of the invention.

FIGS. 5-7 are top views of backlight modules according to a second to a fourth embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

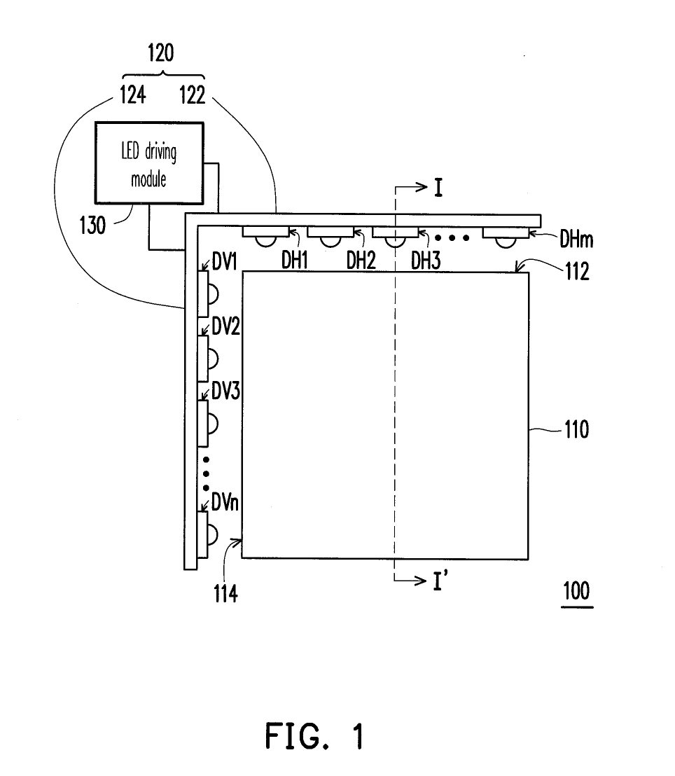

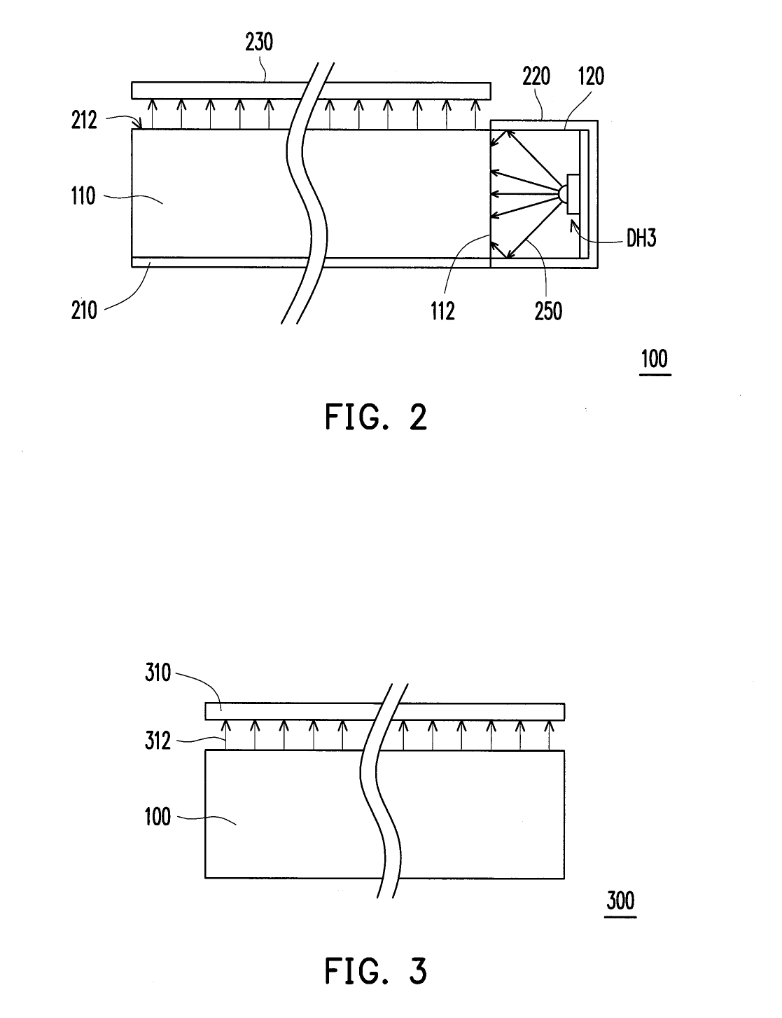

FIG. 1 is a top view of a backlight module 100 according to a first embodiment of the invention. FIG. 2 is a cross-sectional view of the backlight module 100 in FIG. 1 along a vertical line IT. In order to clearly show the characteristic of the backlight module 100 in the drawings, some components (for example, a base plate 210, a reflective cover 220, and an optical film set 230) of the backlight module 100 are omitted in FIG. 1 but shown in FIG. 2.

Referring to both FIG. 1 and FIG. 2, the backlight module 100 includes a light-guide plate 110, a light source module 120, and a light emitting diode (LED) driving module 130. The light-guide plate 110 may be disposed on the base plate 210. The light-guide plate 110 has an upper side surface 112 and a left side surface 114 tangent with the upper side surface 112, wherein the extending direction of the upper side surface 112 is perpendicular to the extending direction of the left side surface 114. The upper side surface 112 and the left side surface 114 are both light incident surfaces of the light-guide plate 110. In short, the light-guide plate 110 in the present embodiment has at least two light incident surfaces.

The light source module 120 is disposed beside the light incident surfaces of the light-guide plate 110. Namely, the light source module 120 is disposed beside the upper side surface 112 and the left side surface 114. In the present embodiment, the light source module 120 may be an L-shaped LED light bar. Herein the horizontal part of the L-shaped LED light bar is referred to as a LED light bar 122, and the vertical part thereof is referred to as a LED light bar 124. In some embodiments, the light source module 120 may also be an aggregate of a LED light bar 122 facing the upper side surface 112 of the light-guide plate 110 and a LED light bar 124 facing the left side surface 114 of the light-guide plate 110. Namely, the LED light bar 122 and the LED light bar 124 can be collectively referred to as a light source module 120.

A plurality of first LED units DH1-DHm is disposed on the portion of the LED light bar 122 of the light source module 120 that faces the upper side surface 112 of the light-guide plate 110, and a plurality of second LED units DV1-DVn is disposed on the portion of the LED light bar 124 of the light source module 120 that faces the left side surface 114 of the light-guide plate 110, wherein m and n are both positive integers greater than 1. In order to conveniently describe the structure of the backlight module 100 in detail, herein the backlight module 100 and the first LED units DH1-DHm are described by taking the first LED unit DH3 ran through by the vertical line I-I′ (as shown in FIG. 2) as an example. The cross-sectional view of the second LED units DV1-DVn in the backlight module 100 is similar to that illustrated in FIG. 2 therefore will not be described herein.

The first LED unit DH3 will be described as an example by referring to both FIG. 1 and FIG. 2. After a light beam 250 emitted by the first LED unit DH3 enters the upper side surface 112, the light beam 250 is converted into a surface light source by the light-guide plate 110 and output through a light exit surface 212. The LED units DH1-DHm and DV1-DVn in the present embodiment may be red LEDs, green LEDs, or blue LEDs, or a white light source composed of aforementioned LEDs, or any other type of LEDs that can be used as backlight sources.

A LED offers a higher light directivity than a general cold cathode fluorescent lamp (CCFL). Thus, in the present embodiment, an optimal optical coupling efficiency between the LED units DH1-DHm and DV1-DVn and the light-guide plate 110 can be achieved by adopting LED as light source. In order to further improve the usage efficiency of the light source, in the present embodiment, a reflective cover 220 is selectively disposed beside the light incident surfaces of the light-guide plate 110, and the light source module 120 is disposed between the reflective cover 220 and the light-guide plate 110, so that the light beams emitted by the LED units DH1-DHm and DV1-DVn (for example, the light beam 250 emitted by the first LED unit DH3) can enter the light-guide plate 110 through the reflection of the reflective cover 220.

Additionally, an optical film set 230 may be further disposed beside the light exit surface 212 of the light-guide plate 110 to improve the luminance and light uniformity of the backlight module 100. The optical film set 230 may be one or a combination of a diffuser, a brightness enhancement film, and a prism sheet. Moreover, referring to FIG. 1 again, the LED driving module 130 is coupled to the light source module 120 for respectively controlling the luminance of the first LED units DH1-DHm and the second LED units DV1-DVn.

FIG. 3 is a cross-sectional view of a liquid crystal display (LCD) device 300 according to the first embodiment of the invention. The LCD device 300 includes the backlight module 100 described above and a LCD panel 310. The LCD panel 310 is disposed above the light exit surface 212 of the light-guide plate 110 illustrated in FIG. 2 and uses a surface light source 312 provided by the backlight module 100 as its display light source.

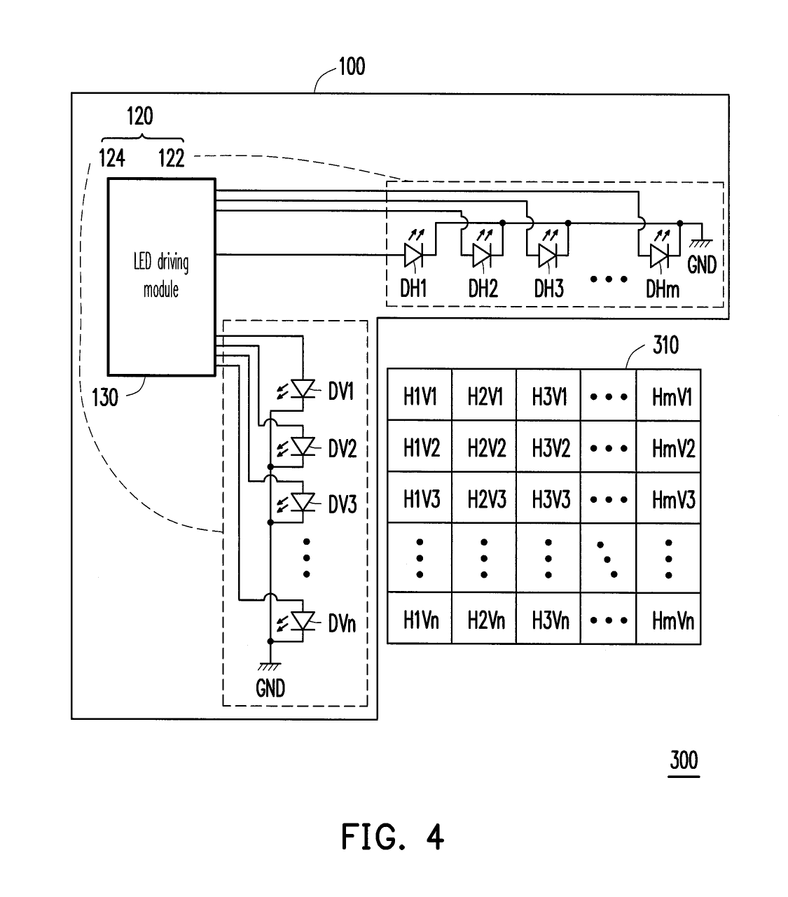

Through the structure of the backlight module 100, the LCD device 300 adopting the backlight module 100 can adjust the brightness of each subarea according to the image content to be displayed on the LCD panel by using an image processing chip, a brightness calculation algorithm, or a timing controller capable of parsing the image content. This concept will be explained below with reference to both FIG. 3 and FIG. 4. FIG. 4 is a top view of the LCD device 300 according to the first embodiment of the invention. In order to prevent the LCD panel 310 and the light-guide plate 110 from being confused, only the LCD panel 310 is illustrated in FIG. 4, and the light-guide plate 110 illustrated in FIG. 1 is not shown in FIG. 4. Thus, the backlight module 100 in FIG. 4 only includes the LED driving module 130 and the light source module 120.

In FIG. 4, a single LED is illustrated as an example of the first LED units DH1-DHm and the second LED units DV1-DVn in the light source module 120, and the LED is illustrated as a circuit component for the convenience of description. One ends of the LED units DH1-DHm and DV1-DVn receive a ground voltage GND, and another ends thereof are controlled by the LED driving module 130. However, as described above, the LED units DH1-DHm and DV1-DVn may also be different types of LEDs (for example, red, green, and blue LEDs) and may constitute a white light source through light mixing. Thus, the circuit component and the coupling thereof illustrated in FIG. 4 is only an example.

As shown in FIG. 4, the LCD panel 310 and the light-guide plate 110 behind it can be divided into a plurality of subareas H1V1-HmVn according to the arrangement and relative positions of the first LED units DH1-DHm and the second LED units DV1-DVn. Each of the subareas H1V1-HmVn is respectively corresponding to one of the first LED units DH1-DHm and one of the second LED units DV1-DVn. For example, the subarea H1V1 is corresponding to the first LED unit DH1 and the second LED unit DV1, the subarea H2V3 is corresponding to the first LED unit DH2 and the second LED unit DV3, and so on.

Accordingly, the LCD device 300 can respectively adjust the luminance of the first LED units DH1-DHm and the second LED units DV1-DVn corresponding to the subareas H1V1-HmVn according to image contents to be respectively displayed within the subareas H1V1-HmVn of the LCD panel 310 by using a backlight brightness adjusting technique (for example, an image processing chip, a brightness calculation algorithm, or a timing controller capable of parsing the image content). The image contents may be pixel information, color gamut, contrast, or other information that can be referred by the backlight brightness adjusting technique and is to be displayed within the subareas H1V1-HmVn.

Below, an example will be described as a reference. Herein it is assumed that the LED units DH1-DHm and DV1-DVn are red, green, and blue LEDs. If the image content corresponding to the subarea H1V1 on the LCD panel 310 and the pixel information thereof are mostly blue, the LED driving module 130 in FIG. 4 can be controlled through aforementioned backlight brightness adjusting technique to increase the luminance of blue LEDs in the first LED unit DH1 and the second LED unit DV1 and slightly decrease the luminance of the LEDs in other colors, so that the LCD device 300 can have high color contrast and low power consumption.

If the image content corresponding to the subarea H3V3 is mostly red, the LED driving module 130 in FIG. 4 can also be controlled through aforementioned backlight brightness adjusting technique to increase the luminance of red LEDs in the first LED unit DH3 and the second LED unit DV3 and slightly decrease the luminance of the LEDs in other colors. In other embodiments, the LED driving module 130 can also be controlled according to the image contents corresponding to the subareas H1V1-HmVn through suitable brightness calculation algorithm and hardware structure, so as to allow the LED driving module 130 to dynamically adjust the brightness of each of the subareas H1V1-HmVn. However, these embodiments will not be described herein.

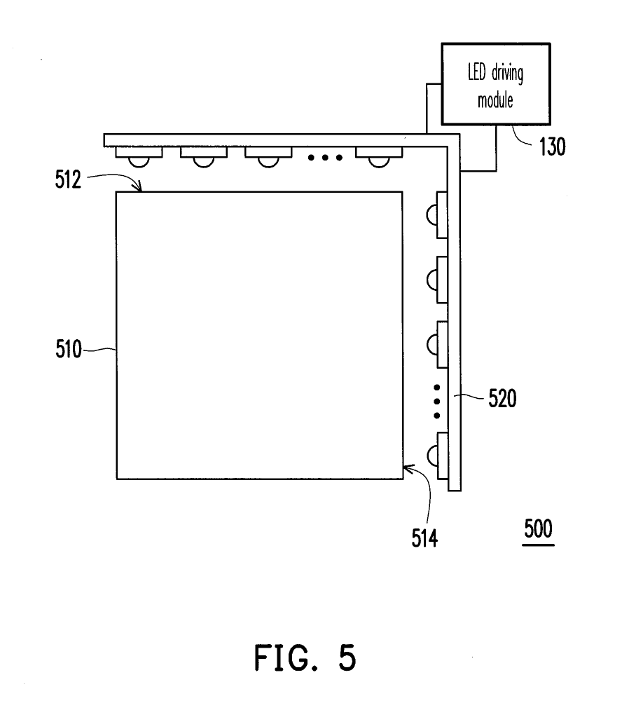

It should be mentioned that in the backlight module 100 illustrated in FIG. 1, the light incident surfaces of the light-guide plate 110 are the upper side surface 112 of the light-guide plate 110 and the left side surface 114 of the light-guide plate 110. Thus, the light source module 120 is the L-shaped LED light bar illustrated in FIG. 1. However, the invention is not limited thereto. FIGS. 5-7 are top views of backlight modules 500, 600, and 700 according to a second to a fourth embodiment of the invention.

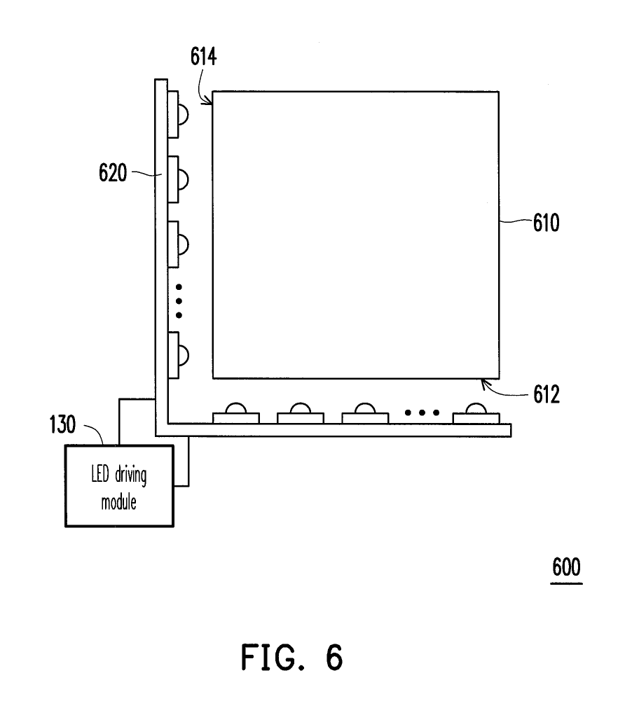

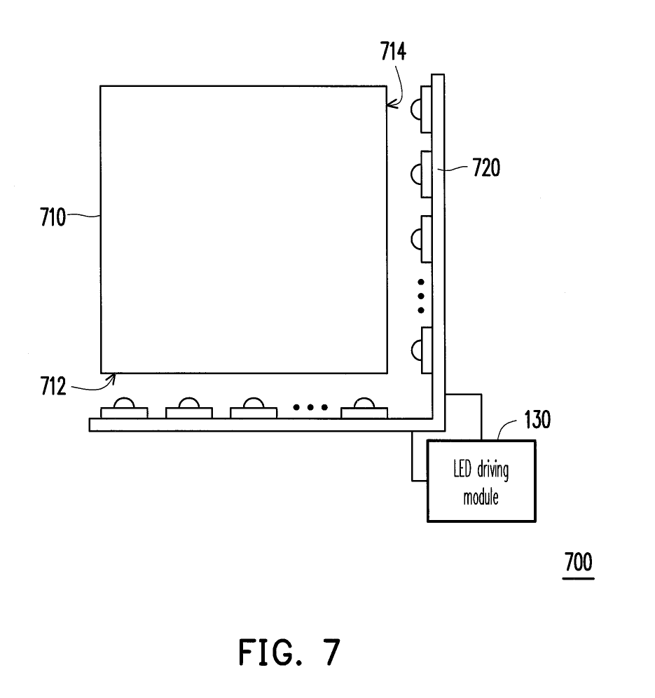

Referring to FIGS. 5-7, the second to the fourth embodiment are similar to the first embodiment described above. However, in the backlight module 500 illustrated in FIG. 5, the light incident surfaces of the light-guide plate 510 are the upper side surface 512 and the right side surface 514 of the light-guide plate 510. In the backlight module 600 illustrated in FIG. 6, the light incident surfaces of the light-guide plate 610 are the lower side surface 612 and the left side surface 614 of the light-guide plate 710. In the backlight module 700 illustrated in FIG. 7, the light incident surfaces of the light-guide plate 710 are the lower side surface 712 and the right side surface 714 of the light-guide plate 710. Thereby, the position of the L-shaped LED light bar changes with the light source modules 520, 620, and 720 in the second to the fourth embodiment, and the contents of the second to the fourth embodiment should be understood by those skilled in the art according to the content of the first embodiment therefore will not be described herein.

As described above, in a backlight module provided by an embodiment of the invention, an L-shaped LED light bar is disposed beside a first side surface and a tangent second side surface of a light-guide plate. Accordingly, the LCD device can respectively control the LED units on the first side surface and the second side surface in the L-shaped LED light bar, so as to dynamically adjust the brightness of each subarea on the LCD device. Thereby, the backlight module in the present embodiment has the advantages of high image contrast and low power consumption offered by a direct type backlight module and maintains the thickness of a side-edge backlight module.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A backlight module, comprising:
a light-guide plate, having a first side surface and a second side surface, wherein the second side surface is tangent with the first side surface; and
a light source module, disposed beside the first side surface and the second side surface of the light-guide plate, wherein a plurality of first light emitting diode (LED) units and a plurality of second LED units are respectively disposed at portions of the light source module that face the first side surface and the second side surface of the light-guide plate.

2. The backlight module according to claim 1 further comprising:
a LED driving module, coupled to the light source module for respectively controlling luminance of the first LED units and the second LED units.

3. The backlight module according to claim 2, wherein the light-guide plate is divided into a plurality of subareas, each of the subareas is respectively corresponding to one of the first LED units and one of the second LED units, and the LED driving module dynamically adjusts the luminance of the first LED unit and the second LED unit corresponding to each of the subareas according to an image content corresponding to the subarea.

4. The backlight module according to claim 1, wherein an extending direction of the first side surface and an extending direction of the second side surface are perpendicular to each other.

5. The backlight module according to claim 1, wherein the light source module is an L-shaped LED light bar.

6. The backlight module according to claim 1, wherein the first LED units and/or the second LED units comprise at least one of a red LED, a green LED, and a blue LED.

7. The backlight module according to claim 1 further comprising a reflective cover disposed beside the first side surface and the second side surface, wherein the light source module is located between the reflective cover and the light-guide plate.

8. The backlight module according to claim 1 further comprising an optical film set disposed beside a light exit surface of the light-guide plate.

9. The backlight module according to claim 8, wherein the optical film set comprises at least one of a diffuser, a brightness enhancement film, and a prism sheet.

10. A liquid crystal display (LCD) device, comprising:
a backlight module, comprising:
a light-guide plate, having a first side surface and a second side surface, wherein the second side surface is tangent with the first side surface; and
a light source module, disposed beside the first side surface and the second side surface of the light-guide plate, wherein a plurality of first LED units and a plurality of second LED units are respectively disposed at portions of the light source module that face the first side surface and the second side surface of the light-guide plate; and
a LCD panel, disposed at a light exit surface of the light-guide plate.

11. The LCD device according to claim 10, wherein the backlight module further comprises:
a LED driving module, coupled to the light source module for respectively controlling luminance of the first LED units and the second LED units.

12. The LCD device according to claim 11, wherein the LCD panel and the light-guide plate are divided into a plurality of subareas, each of the subareas is respectively corresponding to one of the first LED units and one of the second LED units, and the LED driving module dynamically adjusts the luminance of the first LED unit and the second LED unit corresponding to each of the subareas according to an image content displayed on the LCD panel within the subarea.

13. The LCD device according to claim 10, wherein an extending direction of the first side surface and an extending direction of the second side surface are perpendicular to each other.

14. The LCD device according to claim 10, wherein the light source module is an L-shaped LED light bar.

15. The LCD device according to claim 10, wherein the first LED units and/or the second LED units comprise at least one of a red LED, a green LED, and a blue LED.
